(19) United States
(12) Patent Application Publication
(10) Pub. No.: US 2004/0150757 A1
(43) Pub. Date: Aug. 5, 2004

(54) Projection type display device

(75) Inventors: Atsushi Sekine, Kasukabe-shi (JP); Tetsuo Hattori, Yokohama-shi (JP)

Correspondence Address: MORGAN LEWIS & BOCKIUS LLP, 1111 PENNSYLVANIA AVENUE NW, WASHINGTON, DC, 20004, US

(73) Assignee: Nikon Corporation

(21) Appl. No.: 10/747,072

(22) Filed: Dec. 30, 2003

(30) Foreign Application Priority Data
Jan. 9, 2003 (JP) 2003-003081
Aug. 12, 2003 (JP) 2003-292064

(51) Int. Cl. G02F 1/1335

(52) U.S. Cl. 349/5

(57) ABSTRACT

A projection type display device includes: a color separation optical system which separates light from a light source into light beams of a plurality of colors; and a plurality of polarization beam splitters, one being provided for each of the light beams of the plurality of colors which have been separated by the color separation optical system. The polarization beam splitter includes: an incidence face upon which light beam is incident; a polarization splitting plane that is obliquely arranged to achieve a predetermined angle which is smaller than 90° and greater than 45° between the incidence face and the polarization splitting plane; a first emitting face that is arranged perpendicular to the incidence face and from which light beam which has been incident upon the incidence face and has been reflected at the polarization splitting plane is emitted; and a second emitting face that is arranged parallel to the first emitting face and from which light beam which has been incident upon the first emitting face and has passed through the polarization splitting plane is emitted. And the polarization beam splitters are arranged so that in each of the polarization beam splitters, the light beam separated by the color separation optical system is incident upon the polarization splitting plane with an incident angle achieving by subtracting the predetermined angle from 90 degrees.

### INCORPORATION BY REFERENCE

The disclosures of the following priority applications are herein incorporated by reference: Japanese Patent Application No. 2003-003081, filed Jan. 9, 2003; and Japanese Patent Application No. 2003-292064, filed Aug. 12, 2003.

### BACKGROUND OF THE INVENTION

1. Field of the Invention

The present invention relates to a projection type display device.

2. Description of the Related Art

There is a per se known type of small sized projection type display device (for example, refer to U.S. Pat. No. 6,588,905), in which light from a light source is color separated, beams of the various colors of light after color separation are conducted to reflection type light valves for light of each of these colors and are modulated thereby, the beams of modulated light of the various colors from these reflection type light valves are composed together, and the composed light is projected towards a screen.

Generally, electronic write in type light valves are employed for these light valves. In such light valves, a plurality of non linear switching elements such as TFT or the like are provided upon a substrate so as to correspond to pixels (picture elements). With such TFT elements, voltages which correspond to respective picture signals are selectively applied to modulation layers which correspond to each of the pixels, in other words, to liquid crystal layers which are arranged in the form of a matrix. The arrangement of the liquid crystal molecules in those of the liquid crystal layers to which such voltage has been applied is altered, and it is arranged for said liquid crystal layers to play the role of phase plates. Accordingly, the light which is incident upon this light valve, by being emitted through said liquid crystal layer, is emitted as modulated light whose polarization has a different direction of vibration from that of its polarization when it was incident.

In this type of light valve, the gap portions between the pixels are arranged in the form of a grating, and this constitutes a diffraction grating with respect to the incident light. Due to this, the modulated light is not only emitted as so called zero-order light, but also includes diffracted light of ±1st order, ±2nd order . . . which is emitted. With the projection type display device disclosed in the abovementioned U.S. Pat. No. 6,588,905, there is the problem that this diffracted light which is included in the modulated light is internally reflected from the side surfaces of the polarization beam splitter, and that images which are not required (so called ghost images) may be projected in positions upon the screen other than the specified position for the image.

### SUMMARY OF THE INVENTION

A projection type display device according to the present invention, comprises: a color separation optical system which color-separates light from a light source into light beams of a plurality of colors; a plurality of polarization beam splitters, one being provided for each of the light beams of the plurality of colors which have been color-separated by the color separation optical system, each of which reflects one of the color-separated light beams on a polarization splitting section and emits the reflected the light beam towards a reflection type light valve which is provided for each of the plurality of colors, and which also then passes modulated light which is incident from the reflection type light valve through the polarization splitting section and emits the passed modulated light; a color composition optical system which color composes the modulated light beams of the plurality of colors which have been emitted from the polarization beam splitters; and a projection optical system which comprises an aperture stop which projects an image using the light beams which have been color composed, and: each of the polarization beam splitters which are provided for the plurality of colors comprises the polarization splitting section, a first triangular prism and a second triangular prism; the cross sectional shape of the first triangular prism is a right angled triangle which has a first vertex angle of 90°, a second vertex angle which is greater than 45°, and a third vertex angle which is smaller than 45°; the polarization splitting section is provided at a contacting surface of engagement between a face of the first triangular prism which opposes the first vertex angle thereof and one of faces of the second triangular prism; the color-separated light is incident upon a face of the first triangular prism which opposes the third vertex angle thereof; and an angle of incidence of an optical axis of the color-separated light and is incident upon an incidence face of the first triangular prism is set so that an optical axis of light which is traveling through the first triangular prism is incident upon the polarization splitting section at an angle of incidence which is the same angle as the third vertex angle.

In this projection type display device, it is preferred that a vertex angle of the second triangular prism which is contacted against the second vertex angle of the first triangular prism is the same angle as the third vertex angle of the first triangular prism.

Also, it is preferred that the color composition optical system comprises a cross dichroic prism.

Also, it is preferred that: the color composition optical system comprises a compound prism which comprises a third triangular prism, a fourth triangular prism and a fifth triangular prism, all of which have mutually different cross sectional shapes and are attached to one another; a first dichroic film is provided between the third triangular prism and the fourth triangular prism; and a second dichroic film is provided between the fourth triangular prism and the fifth triangular prism.

Also, it is preferred that the color separation optical system comprises: a cross dichroic mirror which comprises a first dichroic mirror which has characteristic of reflecting one of the light beams of the plurality of colors, and a second dichroic mirror which has characteristic of reflecting rest of the light beams, to be mutually orthogonal; and a plurality of mirrors which are arranged so as respectively to change directions of the light beams which have been reflected by the cross dichroic mirror. In this case, it is preferred that the mirrors deflect the directions of the light beams which have been reflected by the cross dichroic mirror through an angle which is greater than 90° and is less than 180°.

In the above projection type display devices, it is preferred that the color separation optical system separates the light from the light source into three beams of red, green, and blue light. In this case, it is preferred that the color separation optical system comprises: a cross dichroic mirror which comprises a first dichroic mirror which has characteristic of reflecting one of the three beams of colors, and a second dichroic mirror which has characteristic of reflecting a mixture of the other two of the three beams of colors, to be mutually orthogonal; a plurality of mirrors which respectively deflect directions of propagation of the light beams which have been reflected by the cross dichroic mirror through an angle which is greater than 90° and is less than 180°; and a third dichroic mirror which has characteristic of reflecting one of the light beams of two colors in the mixture light beam which has been deflected by the mirrors, and of being transparent to the other of the light beams of two colors. Furthermore, it is preferred that light which is modulated by and is reflected from the reflection type light valve is incident upon a second face of the first triangular prism with an angle of incidence of an incident optical axis being zero, and the analyzed light which is emitted from the polarization beam splitter is emitted so that an angle of emittance of an emittance optical axis from an emittance face of the second triangular prism is zero degrees.

Another projection type display device according to the present invention comprises: a color separation optical system which color-separates light from a light source into light beams of a plurality of colors; a plurality of polarization beam splitters, one being provided for each of the light beams of the plurality of colors which have been color-separated by the color separation optical system, each of which reflects one of the color-separated light beams on a polarization splitting section which is provided for that color and emits the reflected light beam towards a reflection type light valve which is provided for each of the plurality of colors, and which also then passes modulated light which is incident from the reflection type light valve through the polarization splitting section and emits the passed modulated light; a color composition optical system which color composes the modulated light beams of the plurality of colors which have been emitted from the polarization beam splitters; and a projection optical system which comprises an aperture stop which projects an image using the light beams which have been color composed, and: each of the polarization beam splitters which are provided for the plurality of colors is built so that an angle of incidence of the color-separated light upon an incidence face of the color-separated light becomes a predetermined angle which is different from zero, and also so that an optical axis of the modulated light which is incident upon the beam splitter from the reflection type light valve is parallel to the incidence face of the separated light beam.

In this projection type display device, it is preferred that the color separation optical system separates the light from the light source into three beams of red, green, and blue light.

Another projection type display device according to the present invention comprises: a polarization beam splitter; a reflection type light valve; and a projection lens, and: the polarization beam splitter comprises a polarization splitting section, a first triangular prism and a second triangular prism, reflects light incident from a light source at the polarization splitting section, and emits the reflected light to the reflection type light valve; the reflection type light valve modulate the light incident from the polarization beam splitter and emits the modulated light to the polarization beam splitter; the polarization beam splitter emits the modulated light which has passed through the polarization splitting section, to the projection lens as an analyzed light; the projection lens projects the analyzed light; a cross sectional shape of the first triangular prism is a right angled triangle which has a first vertex angle of 90°, a second vertex angle which is greater than 45°, and a third vertex angle which is smaller than 45°; the polarization splitting section is provided at a contacting surface of engagement between a face of the first triangular prism which opposes the first vertex angle thereof and one of faces of the second triangular prism; the light from the light source is incident upon an incidence face of the first triangular prism which opposes the third vertex angle thereof, and an angle of incidence of an optical axis upon the incidence face is set so that an optical axis of light which is traveling through the first triangular prism is incident upon the polarization splitting section at an angle of incidence which is the same angle as the third vertex angle.

Another projection type display device according to the present invention comprises: a polarization beam splitter; a reflection type light valve; and a projection lens, and: the polarization beam splitter comprises a polarization splitting section and also a first triangular prism and a second triangular prism which sandwich the polarization splitting section between them, reflects light incident from a light source at the polarization splitting section, and emits the reflected light to the reflection type light valve; the reflection type light valve modulate the light incident from the polarization beam splitter and emits the modulated light to the polarization beam splitter; the polarization beam splitter emits the modulated light which has passed through the polarization splitting section, to the projection lens as an analyzed light; the projection lens projects the analyzed light; and the light from the light source is incident upon a first face of the first triangular prism with an optical axis being incident an angle of incidence which is different from zero, and light which is reflected by the polarization splitting section is emitted so that an angle of emittance of an emittance optical axis from a second face of the first triangular prism is zero degrees.

A polarization beam splitter according to the present invention comprises: an incidence face upon which light beam is incident; a polarization splitting plane that is obliquely arranged to achieve a predetermined angle which is smaller than 90° and greater than 45° between the incidence face and the polarization splitting plane; a first emitting face that is arranged perpendicular to the incidence face and from which light beam which has been incident upon the incidence face and has been reflected at the polarization splitting plane is emitted; and a second emitting face that is arranged parallel to the first emitting face and from which light beam which has been incident upon the first emitting face and has passed through the polarization splitting plane is emitted.

Another projection type display device according to the present invention, comprises: a color separation optical system which separates light from a light source into light beams of a plurality of colors; and a plurality of polarization beam splitters, one being provided for each of the light beams of the plurality of colors which have been separated by the color separation optical system, and: each of the polarization beam splitters is the above polarization beam splitter according to the present invention; the polarization beam splitters are arranged so that in each of the polarization beam splitters, the light beam separated by the color separation optical system is incident upon the polarization splitting plane with an incident angle achieving by subtracting the predetermined angle from 90 degrees.

In this projection type display device, it is preferred that: the color separation optical system separates the light from the light source into light beams of three colors; three of the polarization beam splitters are provided; and the three of the polarization beam splitters are arranged so that the second emitting faces of the adjacent polarization beam splitters are perpendicular to each other. In this case, it is preferred that there are further provided: modulation devices each of which is arranged at a side of the first emitting face of the polarization beam splitter, modulates light beam emitted from the first emitting face of the polarization beam splitter, emits the modulated light beam to the first emitting face; a color composition optical system which is arranged at sides of the second emitting faces of the polarization beam splitters, color composes the modulated light beams emitted from the second emitting faces; and a projection optical system which projects an image using the color composed light beams and has an aperture stop having a numerical aperture smaller than a predetermined value.

### BRIEF DESCRIPTION OF THE DRAWINGS

FIG. 1 is a basic structural figure showing a projection type display device according to a first preferred embodiment of the present invention.

FIG. 2 is an enlarged view of a polarization beam splitter and a reflection type light valve for green colored light.

FIG. 3 is a plan structural view of a projection type display device according to a second preferred embodiment of the present invention.

FIG. 4 is a plan structural view of a projection type display device according to a third preferred embodiment of the present invention.

### DESCRIPTION OF THE PREFERRED EMBODIMENTS

In the following, various preferred embodiments of the present invention will be explained with reference to the appended drawings.

The First Preferred Embodiment

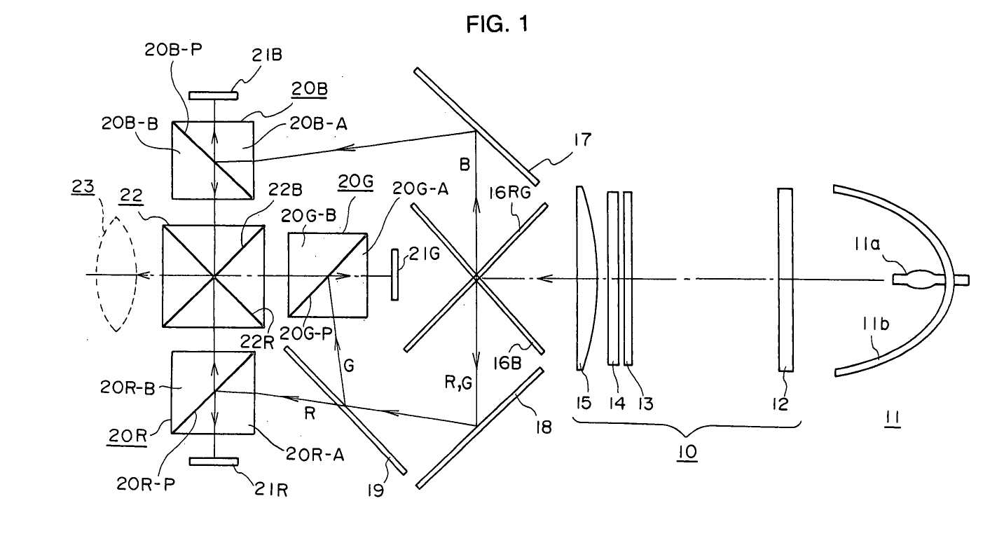

FIG. 1 is a basic structural figure showing a projection type display device (projector) according to a first preferred embodiment of the present invention. Referring to this figure, this projection type display device (apparatus) comprises a light source 11, a polarized light illumination device 10, dichroic mirrors 16B and 16RG, reflective bending mirrors 17 and 18, a dichroic mirror 19, an polarization beam splitter 20R for red light, a polarization beam splitter 20G for green light, a polarization beam splitter 20B for blue light, a reflection type light valve 21R for red light, a reflection type light valve 21G for green light, a reflection type light valve 21B for blue light, a cross dichroic prism 22, and a projection lens 23.

The light source 11 comprises a lamp or the like 11a and a concave mirror 11b of parabolic shape. An approximately parallel ray bundle which has been emitted from the light source 11 is converted by the polarized light illumination device 10 into approximately simply polarized light (S polarized light which has a direction of oscillation in the direction perpendicular to the drawing paper). This polarized light illumination device 10 comprises a first lens plate 12, a second lens plate 13, a polarized light conversion device 14, and a condenser lens 15. The first lens plate 12 includes a plurality of lenses arranged as a matrix in a plane. The second lens plate 13 includes a plurality of lenses arranged in a plane near the focal point positions of the respective lenses of the first lens plate 12. And the first lens plate 12 separates the approximately parallel ray bundle into a plurality of intermediate ray bundles.

The polarized light conversion device 14 comprises a plurality of polarization splitter films, a reflective film which is arranged in parallel with respect to each of these polarization films, and halfwave phase plates which are arranged at predetermined emission surfaces. For a ray bundle which is emitted from the second lens plate 13, this polarized light conversion device 14 converts the P polarized light which passes through the polarization splitter film into S polarized light by the halfwave phase plate, and then emits said S polarized light. Furthermore, the S polarized light which is reflected by the polarization splitter film is incident upon the adjacent polarization splitter film, and is reflected by said polarization splitter film to be emitted as S polarized light. The condenser lens 15 illuminates the simply polarized light of the plurality of intermediate ray bundles which have been separated by the above described first lens plate 12 and are emitted from the above described halfwave phase plates and polarization splitter films upon the light valve as mutually superimposed upon one another. Due to this structure, the source light from the light source 11 is converted into simply polarized light (S polarized light, in this embodiment).

The light from the light source which has been emitted from the polarized light illumination device 10 is incident upon the cross dichroic mirror. The cross dichroic mirror consists of the dichroic mirror 16B and the dichroic mirror 16RG. Each of the dichroic mirrors 16B and 16RG is arranged so as to subtend an angle of incidence of 45° with respect to the incident optical axis, and they are mutually orthogonal so as to define an X shape. The dichroic mirror 16B is endowed with the characteristic of reflecting B (blue) light. On the other hand, the dichroic mirror 16RG is endowed with the characteristic of reflecting R (red) and G (green) light. The cross dichroic mirror (16B, 16RG) color-separates the source light which is incident into two beams which proceed in mutually opposite directions perpendicular to the incident optical axis—one beam of B light, and one beam which consists of a mixture of R light and G light. Here, the optical axis means the central axis of the ray bundle.

The B light which has been thus color separated is incident upon a reflective bending mirror 17 which is disposed so that the incident angle which it subtends with the optical axis of incidence is less than 45°. This reflective bending mirror 17 reflects the B light which is incident towards the polarization beam splitter 20B for blue light.

The mixture of R light and G light which has thus been color separated is incident upon the other reflective bending mirror 18, which also is disposed so that the incident angle which it subtends with the optical axis of incidence is less than 45°. This reflective bending mirror 18 reflects the mixture of R and G light which is incident towards the dichroic mirror 19. This dichroic mirror 19 is slantingly disposed so that the incident angle which it subtends with the optical axis of incidence of the mixed R and G light is greater than 45°. The dichroic mirror 19 is endowed with the characteristic of reflecting G light while being transparent to R light. Thus this dichroic mirror 19 separates the mixed R and G light which is incident into reflected G light and transmitted R light. In this manner, the system comprising the dichroic mirrors 16B and 16RG, the dichroic mirror 19, and the reflective bending mirrors 17 and 18 constitutes a color separation optical system which causes the light from the light source to be separated into the three primary colors, i.e. into R light, G light, and B light.

The G light which has been thus color separated proceeds towards the polarization beam splitter 20G for green light. Furthermore, the R light which has been thus color separated proceeds towards the polarization beam splitter 20R for red light.

The polarization beam splitter 20B for blue light comprises a prism 20B-A which has one side face upon which a beam of blue light is incident, one side face which constitutes a polarization splitting section 20B-P, and another side face which confronts the reflection type light valve 21B for blue light, and a prism 20B-B of the same shape as said prism 20B-A.

The polarization beam splitter 20G for green light comprises a prism 20G-A which has one side face upon which a beam of green light is incident, one side face which constitutes a polarization splitting section 20G-P, and another side face which confronts the reflection type light valve 21G for green light, and a prism 20G-B of the same shape as said prism 20G-A.

The polarization beam splitter 20R for red light comprises a prism 20R-A which has one side face upon which a beam of red light is incident, one side face which constitutes a polarization splitting section 20R-P, and another side face which confronts the reflection type light valve 21R for red light, and a prism 20R-B of the same shape as said prism 20R-A.

The colored light which is incident upon each of these polarization beam splitters for respective colors is polarization split into beams of S polarized light by being reflected from the polarizing splitting section within the polarization beam splitter and being then emitted from said polarization beam splitter, and into beams of P polarized light by passing through said polarization splitting section and being then emitted from said polarization beam splitter. This preferred embodiment is built so that the S polarized light beams are emitted in the direction of the reflection type light valves so as to be used as illumination light, while the P polarized light is discarded as being useless.

The S polarized blue colored light which has been emitted from the polarization beam splitter for blue light 20B is incident upon the reflection type light valve 21B. Similarly, the S polarized green colored light which has been emitted from the polarization beam splitter for green light 20G is incident upon the reflection type light valve 21G. Moreover, the S polarized red colored light which has been emitted from the polarization beam splitter for red light 20R is incident upon the reflection type light valve 21R.

Now the reflection type light valves 21B, 21G, and 21R will be explained. These reflection type light valve are reflection type light valves of the electronic write-in type. In other words, a plurality of non linear switching elements of TFT or the like are respectively provided upon a silicon substrate as corresponding to pixels, and electrodes that define forms of pixels and apply voltage to a liquid crystal layer are respectively connected onto these TFT elements. Furthermore, such a liquid crystal layer is provided over these electrodes. These TFT elements selectively apply voltage to the liquid crystal layer in correspondence to respective image signals. The orientations of the liquid crystal molecules in the liquid crystal layer to which these voltages have been applied change, so that said liquid crystal layer comes to fulfill the function of a phase plate.

The electrodes which apply voltage to the liquid crystal layer also function as reflection plates which reflect light which is incident from the liquid crystal layer side. Accordingly, in the regions of the liquid crystal layer to which the voltage of the reflection type light valve is being applied, the polarized light which is incident from above the liquid crystal layer arrives at these reflection plates via said liquid crystal layer. This light is reflected by these reflection plates and again is emitted via the liquid crystal layer. Since, as described above, the liquid crystal layer to which voltage has been applied fulfills the function of a phase plate, accordingly the reflected light which is emitted from this reflection type light valve is modulated polarized light whose direction of vibration differs from that of the incident polarized light. On the other hand, the polarized light which has been incident upon the liquid crystal layer in its portions which correspond to pixels of the reflection type light valve which are not selected, in other words in regions in which no voltage is being applied by the TFT, proceeds according to the twist structure of the original orientation of the liquid crystal molecules and is reflected by the reflection plates. Since this reflected light proceeds in the reverse direction again according to the same twist structure, it is emitted as polarized light whose direction of vibration is the same as that of the incident polarized light. In this manner, the emitted light which is reflected by this reflection type light valve consists of a mixture of P polarized light which has been modulated, and of S polarized light which has not been modulated. The reflection type light valve may be referred to as a light modulation device.

The blue colored light which has been reflected by and emitted from the reflection type light valve 21B for blue light is incident for a second time upon the polarization beam splitter 20B, and is polarization split into modulated P polarized light which passes through the polarization splitting section 20B-P, and unmodulated S polarized light which is reflected by said polarization splitting section 20B-P. The unmodulated light which is reflected by the polarization beam splitter 20B proceeds in the direction of the light source 11 and is discarded. In the same manner, the green colored light which has been reflected by and emitted from the reflection type light valve 21G for green light is incident for a second time upon the polarization beam splitter 20G, and is polarization split into modulated P polarized light which passes through the polarization splitting section 20G-P, and unmodulated S polarized light which is reflected by said polarization splitting section 20G-P. The unmodulated light which is reflected by the polarization beam splitter 20G proceeds in the direction of the light source 11 and is discarded. Moreover, the red colored light which has been reflected by and emitted from the reflection type light valve 21R for red light is incident for a second time upon the polarization beam splitter 20R, and is polarization split into modulated P polarized light which passes through the polarization splitting section 20R-P, and unmodulated S polarized light which is reflected by said polarization splitting section 20R-P. The unmodulated light which is reflected by the polarization beam splitter 20R proceeds in the direction of the light source 11 and is discarded. Due to this operation, the unmodulated light of the various colors proceeds in the direction of the light source 11 and is discarded.

The modulated P polarized light which has passed through the polarization beam splitter 20B for blue light, in other words the analyzed light, is incident upon the cross dichroic prism 22. In the same manner, the modulated P polarized light which has passed through the polarization beam splitter 20G for green light, which is the analyzed light, and the modulated P polarized light which has passed through the polarization beam splitter 20R for red light, which is the analyzed light, are both incident upon said cross dichroic prism 22.

This cross dichroic prism 22 is a compound prism in which a red light reflective dichroic film 22R and a blue light reflective dichroic film 22B are arranged so as to be mutually orthogonal. The analyzed red light which is incident upon the cross dichroic prism 22 is reflected by the red light reflective dichroic film 22R towards the side of the projection lens 23. Furthermore, the analyzed blue light which is incident upon the cross dichroic prism 22 is reflected by the blue light reflective dichroic film 22B towards the side of the projection lens 23. Moreover, the analyzed green light which is incident upon the cross dichroic prism 22 passes through both the red light reflective dichroic film 22R and also the blue light reflective dichroic film 22B and proceeds towards the side of the projection lens 23. Due to this, the red colored analyzed light, the green colored analyzed light, and the blue colored analyzed light are emitted as color composed light from the same face of the cross dichroic prism 22. This color composed light is incident upon the projection lens 23, and thereby a full color image is projected upon a screen (not shown in the drawings). In this manner, the cross dichroic prism 22 constitutes a color composition optical system.

The projection lens 23 is made so as to be telecentric with respect to the side of the cross dichroic prism 22 by comprising a forward lens group which is arranged on the side of the cross dichroic prism 22, a rear lens group which is arranged on the side of the screen, and an aperture stop (iris) which is arranged at the focal point position of the front lens group. It should be understood that the structure of the projection lens 23 will be described hereinafter. The aperture stop defines the magnitude (numerical aperture NA) of the divergence of the ray bundles which are emitted from single points of the respective emitting surfaces of the reflection type light valves 21B, 21G, and 21R for each of the colors. In other words, an image is projected upon the screen due to those rays, among all the ray bundles which have been emitted from the light valves, which have passed through the aperture stop. Namely, the numerical aperture of the aperture stop should be less than a predetermined value, in other words, the diameter of the aperture stop should be smaller than a predetermined diameter.

The present invention is one which relates, in a projection type display device of the above described basic structure, to the forms of the polarization beam splitter 20R for red light, the polarization beam splitter 20G for green light, and the polarization beam splitter for blue light 20B, and to the angles of incidence of the light beams of the three colors with respect to these polarization beam splitters.

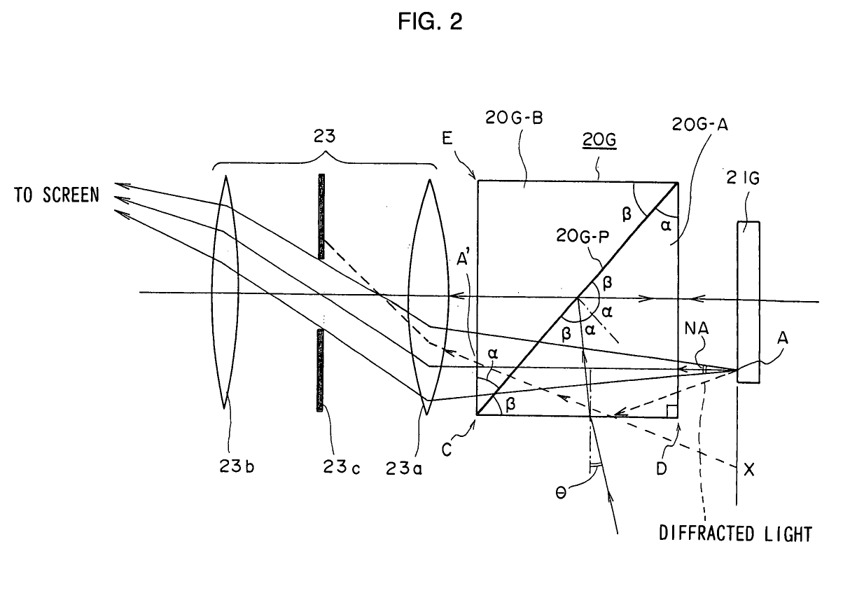

FIG. 2 is an enlarged view showing certain elements in the basic structure of the projection type display device shown in FIG. 1 and described above and related to the green colored light, and specifically showing certain details of the structure of the polarization beam splitter 20G for green light and the reflection type light valve 21G for green light. As has been described above, the projection lens 23 comprises a front lens group 23a, a rear lens group 23b, and an aperture stop 23c. The prism 20G-A to which the incident face for green colored light in the polarization beam splitter 20G belongs is shaped as a triangular prism whose cross sectional shape has the form of a right angled triangle. The vertex (vertical) angle D of this right angled triangular cross sectional shape is a right angle, and its other two vertex angles are mutually different from one another. That is, the vertex angle α is less than 45°, while the vertex angle β is greater than 45°. However of course α+β=90′.

In the polarization beam splitter 20G, the prism 20G-A and the prism 20G-B are attached together while sandwiching the polarization splitter film between them. This attachment (gluing or bonding) portion corresponds to the polarization splitting section 20G-P. In the prism 20G-B which is attached to the prism 20G-A, at least the angle of the vertex which is attached to the vertex angle β of the prism 20G-A is equal to the vertex angle α of said prism 20G-A. Due to this, after the attachment together of the component prisms 20G-A and 20G-B of the polarization beam splitter 20G for green light, its vertex angle C comes to be 90°. And in fact, in this first preferred embodiment of the present invention, the other two vertex angles of the prism 20G-B are equal to the corresponding vertex angles of the prism 20G-A, although according to the most general aspect of the present invention this need not necessarily be the case. In other words, in this first preferred embodiment, the prism 20G-A and the prism 20G-B are formed as identical prisms, and, along with the vertex angle D of the prism 20G-A being equal to the vertex angle E of the prism 20G-B, both being equal to 90°, also, in the prism 20G-B, the angle of its vertex on its side which contacts the vertex angle α of the prism 20G-A is made to be equal to the angle of the vertex angle β of the prism 20G-A. As a result, all of the vertex angles of the cross sectional shape (taken in a sectional plane which is orthogonal to the polarization splitting section 20G-P) of the polarization beam splitter 20G which is constituted by the attachment together of the two prisms 20G-A and 20G-B with the polarization splitting section 20G-P sandwiched between them are equal to 90°; in other words, it is a rectangle.

The green colored light that has been separated by the color separation optical system from the light from the light source and is incident upon the prism 20G-A of the polarization beam splitter 20G is incident from a plane of incidence which is between the vertex angle D and the vertex angle β. The angle of incidence in this case is taken, not as being zero degrees, but as being a predetermined angle θ. This predetermined angle θ is taken so that the green light which is incident upon the prism 20G-A proceeds within the prism 20G-A after having been refracted upon incidence, and its optical axis is incident upon the polarization splitting section 20G-P at the same angle of incidence as the above described vertex angle α. Since, due to this, the angle of reflection of the optical reflection axis which is reflected by the polarization splitting section 20G-P becomes equal to the above described vertex angle α, accordingly the light which is reflected by the polarization splitting section 20G-P is emitted from the plane face which is between the vertex angle D and the vertex angle α of the prism 20G-A so that its optical axis is orthogonal to said plane face. This emitted light is incident upon the reflection type light valve 21G.

The light which is reflected by and emitted from the reflection type light valve 21G is again incident from the above described emission surface (the plane face of the prism 20G-A which is between the vertex angle D and the vertex angle α described above) into the prism 20G-A so that its optical axis is orthogonal thereto. This incident light proceeds within the prism 20G-A and is incident upon the polarization splitting section 20G-P so that its optical axis is at an angle of incidence which is the same as the above described vertex angle α. As has been described above, the polarization splitting section 20G-P is transparent to the modulated light (the P polarized light) in this incident light, while it reflects the unmodulated light (the S polarized light) therein.

The P polarized light which has passed through the polarization splitting section 20G-P is incident upon the prism 20G-B as analyzed light, and proceeds within the prism 20G-B. This analyzed light is emitted from the plane face of the prism 20G-B which is between its vertex angle α and its vertex angle E, orthogonally from said plane face. And the emitted light proceeds towards the projection lens 23. In this manner, the optical axis of the light which is reflected by and emitted from the reflection type light valve 21G becomes parallel to the face (the face between the vertex angle D and the vertex angle β) of incidence of the light source light (the green light) into the polarization beam splitter 20G. It should be noted that the S polarized light which has been reflected by the polarization splitting section 20G-P is discarded, as has been explained above.

Although, in the example shown in FIG. 2, the explanation has been made in terms of using the polarization beam splitter 20G and the reflection type light valve 21G which related to the green light, the arrangements for the red light and the blue light are the same as for the green light.

Now, the components other than the zero order light which are emitted from this reflection type light valve will be explained. In this reflection type light valve, as described above, the electrodes which are connected to a plurality of switching elements which are arranged in the form of a matrix in correspondence to the pixels also serve as reflection plates. The light which is incident upon this reflection type light valve is reflected by these reflection plates in a matrix arrangement and then is emitted. When this light valve is viewed from the incident side, the lattice which is formed by the gap portions of the reflection plates and which defines the shape of each pixel constitutes a diffraction grating. Due to this, not only is so-called zero-order light reflected by and emitted from this light valve, but also 1st order, ±2nd order, . . . diffracted light is reflected and emitted. This type of diffracted light is emitted more to a sideways direction than the most outer edge light ray of the ray bundle that is constituted by the zero-order light.

In FIG. 2, diffracted light is emitted from the point A of the light valve 21G and is incident upon the prism 20G-A of the polarization beam splitter 20G. This diffracted light which is incident proceeds within the prism 20G-A while being internally reflected within the prism 20G-A from the surface of incidence of the green colored light (i.e., the surface between the vertex angle D and the vertex angle β), and is incident upon the prism 20G-B via the polarization splitting section 20G-P. And this diffracted light further proceeds within the prism 20G-B and then is emitted (along the ray A′) from the surface of the prism 20G-B between its vertex angle α and its vertex angle E.

Since, as has been described above, it is arranged for the surface of internal reflection (in other words the incident surface for the green colored light) to be parallel to the optical axis of the light (the zero-order light) which is reflected by and emitted from the reflection type light valve 21G, therefore it is possible to consider the reflected light ray A′ due to the diffracted light as being light which proceeds from a point X upon a surface which is an extension of the liquid crystal surface of the light valve 21G. Since the inclination of this light ray A′ with respect to the optical axis of the zero-order light is greater than the numerical aperture (NA) which is determined by the aperture stop 23c of the projection lens 23, accordingly, even if the diffracted light has been incident upon the projection lens 23, it is intercepted by the above described aperture stop 23c. As a result, it is possible to prevent images due to the diffracted light (so called ghost images) from being projected upon the screen.

According to the first preferred embodiment described above, the following operational benefits are obtained.

(1) Each of the polarization beam splitters 20G, 20B, and 20R is made by adhering together the two triangular prisms whose cross sectional shapes are right angled triangles, with the polarization splitter film between them. The two vertex angles of this right angled triangular cross sectional shape (other than its right angled vertex) are arranged to be the vertex angle α which is less than 45° and the vertex angle β which is greater than 45°. And it is arranged to make the incident faces upon which the light from the light source is incident upon the polarization beam splitters 20G, 20B, and 20R (the faces between their right angled vertices and their vertex angles β), in other words the faces which internally reflect the diffracted light which is incident upon the polarization beam splitters 20G, 20B, and 20R from the light valves 21G, 21B, and 21R, and the optical axis of the reflected light which is reflected by and emitted from the light valves 21G, 21B, and 21R and is again incident upon the polarization beam splitters 20G, 20B, and 20R, to be mutually parallel to one another. Since, as a result, the diffracted light which has been reflected by the above described internal surfaces does not become ray bundles within the numerical aperture (NA) which is determined by the aperture stop 23c of the projection lens 23, thereby it is possible to prevent generation of ghost images due to the diffracted light.

(2) Since the two triangular prisms which make up the polarization beam splitter 20G (and 20B and 20R) are identical to one another, it is possible to reduce the cost of manufacture, as compared to a case in which two prisms which have different shapes are utilized.

(3) It is arranged to reflect the mixture of red light and green light, and the blue light, which have been color separated by the dichroic mirrors 16RG and 16B, by the respective reflective bending mirrors 18 and 17, so as to bring them mutually closer to one another. Due to this, it becomes possible to make the device more compact, since it is possible to arrange each of the polarization beam splitters 20B and 20R (20G) closer to the cross dichroic prism 22.

(4) When light is incident from the light source 11 upon the polarization beam splitters 20G, 20B, and 20R, due to the fact that the angle of incidence of the optical axis of the incident light upon each incidence face of the polarization beam splitters 20G, 20B, and 20R is made to be θ, thereby it is arranged that it is incident upon each of the polarization splitting sections of the polarization beam splitters 20G, 20B, and 20R at an angle of incidence (for example, the same as the vertex angle α of the prism 20G-A) which is less than 45°. As a result, it is possible to position each of the polarization beam splitters 20G, 20B, and 20R closer to the cross dichroic prism 22, as compared with the case in which the light is incident upon each of the polarization splitting sections at an angle of incidence of 45°, and this is effective for making the device more compact. Furthermore, it is possible to obtain a brighter projection image, since it is possible to increase the numerical aperture value (NA).

As described above, when light is incident from the light source 11 upon the polarization beam splitters 20G, 20B, and 20R, due to the fact that the angle of incidence of the optical axis of the incident light upon each incidence face of the polarization beam splitters 20G, 20B, and 20R is made to be θ, thereby it is possible to position each of the polarization beam splitters 20G, 20B, and 20R closer to the cross dichroic prism 22. In other words, the angle α, the angle β and the angle D are determined so as to achieve following conditions while positioning each of the polarization beam splitters 20G, 20B, and 20R closer to the cross dichroic prism 22.

The condition 1 is that the plane from which light is emitted to the light valve 21G, 21B or 21R and which is between the vertex angle D and the vertex angle α is orthogonal to the optical axis of the emitted light. The condition 2 is that the plane from which light is emitted to the cross dichroic prism 22 and which is between the vertex angle E and the vertex angle α is orthogonal to the optical axis of the emitted light. The condition 3 is that the plane with which light from the light source is incident upon the polarization beam splitter 20G, 20B, or 20R and which is between the vertex angle D and the vertex angle β is parallel to the optical axis of the above mentioned emitted light.

Furthermore, it should be considered that the optical axis of the incident light upon each incidence face of the polarization beam splitters 20G, 20B, and 20R with θ of the angle of incidence is refracted due to an refractive index n of the prism of the polarization beam splitter.

In FIG. 2, it is assumed that the plane on which the G color light is incident is the incident plane, the plane from which light, which has been reflected on the polarization splitting section (plane) 20G-P, is emitted to the reflection type light valve is the first emitting plane, and the plane from which modulated light from the reflection type light valve, which has passed through the polarization splitting section 20G-P, is emitted is the second emitting plane. In this assuming, the polarization splitting section (plane) 20G-P is arranged obliquely achieving the angle β which is greater than 45 degrees and smaller than 90 degrees between the polarization splitting section (plane) 20G-P and the incident plane. The first emitting plane is arranged so as to be perpendicular or orthogonal to the incident plane. The second emitting plane is arranged so as to be perpendicular or orthogonal to the incident plane and be parallel to the first emitting plane. By using these polarization beam splitters 20G, 20B, and 20R it is possible to position each of the polarization beam splitters 20G, 20B, and 20R closer to the cross dichroic prism 22.

The polarization beam splitters 20G, 20B, and 20R are arranged so that the color light color-separated by the color separation optical system is incident upon the polarization splitting section plane with the incident angle α achieved by α=90−β degrees. By this means the optical axis of light emitting from the first emitting plane is perpendicular to the first emitting plane. Also, the optical axis of modulated light emitting from the second emitting plane is perpendicular to the second emitting plane.

In FIG. 1, since the second emitting planes of the adjacent polarization beam splitters 20G, 20B, and 20R are perpendicular to each other, color composition can be achieved at the cross dichroic prism 22. In other words, the optical axes of modulated light that incident upon the cross dichroic prism 22 from the adjacent polarization beam splitters 20G, 20B, and 20R are perpendicular to each other.

The Second Preferred Embodiment

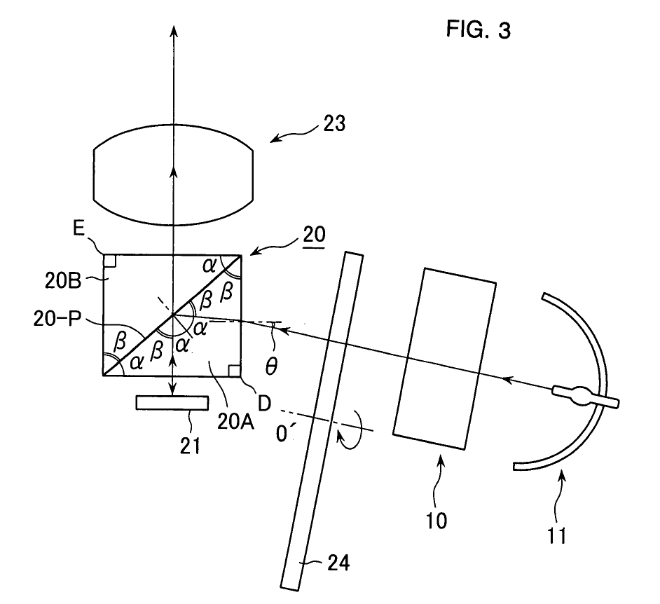

FIG. 3 is a plan structural view of a projection type display device according to a second preferred embodiment of the present invention. Referring to FIG. 3, a time series color separation optical system 24 is disposed between the polarized light illumination device 10 and the polarization beam splitter 20. The polarization beam splitter 20, itself, has the same structure as the polarization beam splitter 20G of FIG. 2. The light source 11, the polarized light illumination device 10, the polarization beam splitter 20, the reflection type light valve 21, and the projection lens 23 are respectively the same as their counterparts in the first preferred embodiment described above, and hence their explanation will here be curtailed, and the explanation of this second preferred embodiment will focus only upon the points in which it differs from the first preferred embodiment.

With this second preferred embodiment of the present invention, it is not necessary to provide a plurality of optical systems to correspond to the plurality of colors; rather, a full color image can be projected upon the screen (not shown in the drawings) by projecting light of a plurality of colors by time division, using the same optical system.

The time series color separation optical system 24 is one in which three filters are formed around the outer circumferential portion of a circular glass plate so as to divide said circumference into three equal portions: a filter which is transparent to red light, a filter which is transparent to green light, and a filter which is transparent to B light. And this time series color separation optical system 24 is rotated at a predetermined angular speed around its central axis O′, so as to pass light from the light source 11 in time sequence through each filter in turn. Due to this, the light which has been emitted from the polarized light illumination device 10 is separated into its colors in a time series manner, and is incident upon the polarization beam splitter 2 at an angle of incidence θ which is different from zero.

The time series color separated red light, green light, and blue light (hereinafter termed the color separated light) is incident upon the polarization beam splitter 20 at its incident face which is between the vertex angle D and the vertex angle β of the prism 20A. The angle of incidence θ is set so that the light which is incident upon the prism 20A proceeds within the prism 20A after having been refracted upon incidence, and its optical axis is incident upon the polarization splitting section 20-P at the same angle of incidence as the vertex angle α. Since, due to this, the angle of reflection of the optical reflection axis which is reflected by the polarization splitting section 20P becomes equal to the vertex angle α, accordingly the light which is reflected by the polarization splitting section 20-P is emitted from the plane face which is between the vertex angle D and the vertex angle α of the prism 20A so that its optical axis is orthogonal to said plane face. This light which is emitted from the polarization beam splitter 20 is incident upon a reflection type light valve 21.

The color separated light (the red light, the green light, and the blue light) which is incident in time series upon the reflection type light valve 21 is modulated by color signals for each of its colors in time series, and thereby modulated light in each of the colors red, green, and blue is emitted in time series. The light which is reflected by and emitted from the reflection type light valve 21 is again incident into the prism 20A from its above described emission surface (the plane face of the prism 20A which is between the vertex angle D and the vertex angle α thereof) so that its optical axis is orthogonal thereto. This incident light proceeds within the prism 20A and is incident upon the polarization splitting section 20-P so that its optical axis is at an angle of incidence which is the same as the above described vertex angle α. As has been described above, the polarization splitting section 20-P is transparent to the modulated light (the P polarized light) in this incident light, while it reflects the unmodulated light (the S polarized light) therein.

The P polarized light which has passed through the polarization splitting section 20-P is incident upon the prism 20B as analyzed light, and proceeds within the prism 20B. This analyzed light is emitted from the plane face of the prism 20B which is between its vertex angle α and its vertex angle E, orthogonally from said plane face. And the light emitted from the polarization beam splitter 20 is projected by the projection lens 23 upon a screen which is not shown in the drawings. Thus an observer is able to view a projection image in full color by observing the series of images in the various colors red, green, and blue which are projected in time series upon the screen.

It should be understood that the projection lens 23 of this second preferred embodiment also is internally equipped with an aperture stop, just like the one shown in FIG. 2 for the first preferred embodiment. Accordingly, in this case as well in which the structure is such that color separation is performed by the time series color separation optical system 24 in time series, it becomes possible, just as in the case of the first preferred embodiment described above, to cut off the ghost light which has been reflected from the side surfaces of the polarization beam splitter 20 from the diffracted light which has been emitted from the reflection type light valve 21, so that it is possible to prevent the generation of ghost images.

In the second preferred embodiment, the optical axis of the light source 11, the polarized light illumination device 10 and the time series color separation optical system 24 does not need to be perpendicular to the optical axis of the modulated light emitted from the polarization beam splitter 20. By this means, the design flexibility can be achieved as to arrangement of various components.

The Third Preferred Embodiment

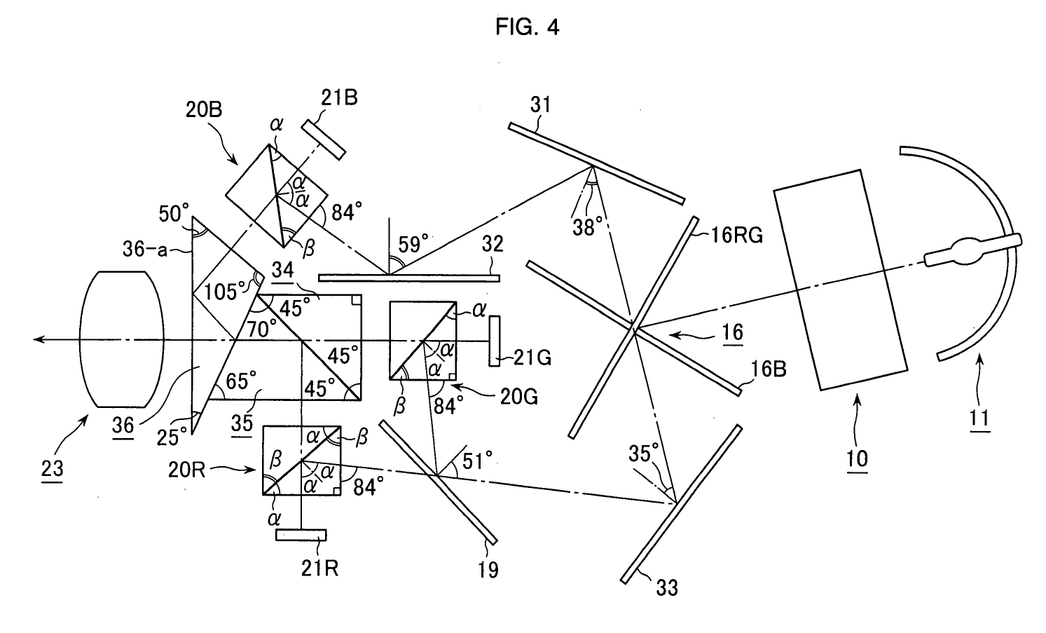

FIG. 4 is a plan structural view of a projection type display device according to a third preferred embodiment of the present invention. Referring to FIG. 4, elements which correspond to counterparts in FIG. 1 for the first preferred embodiment and which have the same functions are denoted by the same reference symbols, and description thereof will herein be curtailed. To compare the structure of this third preferred embodiment with that of the first preferred embodiment shown in FIG. 1, since the arrangement of the dichroic mirrors and the deflection mirrors in the color separation optical system and the constitution of the compound prisms which are included in the color composition optical system are different, the explanation herein will principally focus upon these points of difference.

The cross dichroic mirror 16 is arranged so that the optical axis of the incident light from the light source 11 becomes non parallel with the optical axis of the projection lens 23. This cross dichroic mirror 16 performs color separation upon the light which is incident upon it into blue light which proceeds in one direction, and a mixture of red light and green light which proceeds in the opposite direction. As for the angle of incidence of the optical axis of the blue light which has thus been color separated with respect to the deflection mirror 31, it may for example be incident upon the deflection mirror 31 at an angle of 38°. The deflection mirror 31 reflects the blue light which is thus incident towards the deflection mirror 32. The angle of incidence of the optical axis of the blue light which has thus been reflected with respect to this second deflection mirror 32 may, for example, be set to 59°. The deflection mirror 32 reflects the blue light, and this reflected blue light is incident upon the incidence face of the polarization beam splitter 20B at an angle of incidence which is not a right angle; for example, this angle of incidence may be set to 84°.

On the other hand, as for the angle of incidence of the optical axis of the mixture of red light and green light with respect to the deflection mirror 33, it may for example be incident upon the deflection mirror 33 at an angle of 35°. The deflection mirror 33 reflects this mixture of red light and green light which is thus incident towards the green light reflective dichroic mirror 19. And, as for the angle of incidence of the optical axis of the mixture of red light and green light with respect to the green light reflective dichroic mirror 19, it is set to an angle which is greater than 45°; for example, to 51°.

The green light reflective dichroic mirror 19 performs color separation upon this mixture of red light and green light, resolving it into a beam of green light which is reflected from said mirror 19 and a beam of red light which passes through said mirror 19. These beams of red light and of green light are incident upon the polarization beam splitters 20R and 20G respectively at angles of incidence which are not right angles; for example, these angles of incidence may be set to 84°.

The polarization beam splitters 20B, 20R, and 20G, and the reflection type light valves 21B, 21R, and 21G are the same as their counterparts shown in FIG. 1 and described with reference to the first preferred embodiment, and accordingly description thereof here will be curtailed.

The compound prism is built up from prism members 34, 35, and 36. The prism member 36 is made as a triangular prism, and the three vertex angles of its triangular cross sectional shape are, for example, 50°, 105°, and 25°. The prism member 35 is also made as a triangular prism, and the three vertex angles of its triangular cross sectional shape are, for example, 45°, 65°, and 70°. Likewise, the prism member 34 is made as a triangular prism, and the three vertex angles of its triangular cross sectional shape are, for example, 90°, 45°, and 45°.

The prism members 34 and 35 are attached together with the face of the prism member 34 between its two vertex angles of 45° being laid against the face of the prism member 35 between its vertex angle of 70° and its vertex angle of 45° with the interposition of a red light reflective dichroic film between them. Similarly, the prism members 35 and 36 are attached together with the face of the prism member 35 between its vertex angle of 70° and its vertex angle of 65° being laid against the face of the prism member 36 between its vertex angle of 105° and its vertex angle of 25° with the interposition of a blue light reflective dichroic film between them.

The blue colored analyzed light (the P polarized light) which is emitted from the polarization beam splitter 20B is incident upon the prism member 36 which is included in the compound prism. And the red colored analyzed light (the P polarized light) which is emitted from the polarization beam splitter 20R is incident upon the prism member 35 which is included in the compound prism. Moreover, the green colored analyzed light (the P polarized light) which is emitted from the polarization beam splitter 20G is incident upon the prism member 34 which is included in the compound prism.

The blue light which has been incident upon the prism member 36 proceeds within the prism member 36 and is entirely reflected (internally reflected) by its surface 36-a, and further proceeds within the prism member 36. And then it is reflected by the blue light reflective dichroic film, and is emitted from the surface 36-a and is emitted towards the projection lens 23.

The red light which has been incident upon the prism member 35 proceeds within the prism member 35 and is reflected by the red light reflective dichroic film, and then further proceeds within the prism member 35. And then it passes through both the blue light reflective dichroic film and the prism member 36, and is emitted from the surface 36-a of the prism member 36 towards the projection lens 23.

The green light which has been incident upon the prism member 34 proceeds within the prism member 34 and passes through the red light reflective dichroic film, and then proceeds within the prism member 35. And then it passes through both the blue light reflective dichroic film and the prism member 36, and is emitted from the surface 36-a of the prism member 36 towards the projection lens 23.

As has been explained above, the analyzed light beams of blue color, red color, and green color are all emitted from the same face 36-a of the prism member 36 as light which has been color composed. This color composed light is incident into the projection lens 23, and thereby a full color image is projected upon the screen (not shown in the drawings). The color composition optical system which comprises a compound prism (consisting of the prism members 34, 35, and 36) is constituted in this manner.

When using the color composition optical system which consists of the prism members 34 through 36, the arrangement of the color separation optical system described above (comprising the dichroic mirrors 16 and 19 and the deflection mirrors 31 through 33) is arranged so that the length of the optical path after the color separation to the light valve is the same for each color. The numerical values which have been described above for the angles of incidence and so on have been given merely by way of example.

As has been explained above, it becomes possible, with this third preferred embodiment of the present invention as well, to obtain a projection type display device in which the projection of ghost images due to ghost light radiation is avoided, just as with the first preferred embodiment described above.

The above described embodiments are examples, and various modifications can be made without departing from the spirit and scope of the invention.

What is claimed is:

1. A projection type display device, comprising:
a color separation optical system which color-separates light from a light source into light beams of a plurality of colors;
a plurality of polarization beam splitters, one being provided for each of the light beams of the plurality of colors which have been color-separated by the color separation optical system, each of which reflects one of the color-separated light beams on a polarization splitting section and emits the reflected the light beam towards a reflection type light valve which is provided for each of the plurality of colors, and which also then passes modulated light which is incident from the reflection type light valve through the polarization splitting section and emits the passed modulated light;
a color composition optical system which color composes the modulated light beams of the plurality of colors which have been emitted from the polarization beam splitters; and
a projection optical system which comprises an aperture stop which projects an image using the light beams which have been color composed, wherein:
each of the polarization beam splitters which are provided for the plurality of colors comprises the polarization splitting section, a first triangular prism and a second triangular prism;
the cross sectional shape of the first triangular prism is a right angled triangle which has a first vertex angle of 90°, a second vertex angle which is greater than 45°, and a third vertex angle which is smaller than 45°;
the polarization splitting section is provided at a contacting surface of engagement between a face of the first triangular prism which opposes the first vertex angle thereof and one of faces of the second triangular prism;
the color-separated light is incident upon a face of the first triangular prism which opposes the third vertex angle thereof; and
an angle of incidence of an optical axis of the color-separated light and is incident upon an incidence face of the first triangular prism is set so that an optical axis of light which is traveling through the first triangular prism is incident upon the polarization splitting section at an angle of incidence which is the same angle as the third vertex angle.

2. A projection type display device according to claim 1, wherein
a vertex angle of the second triangular prism which is contacted against the second vertex angle of the first triangular prism is the same angle as the third vertex angle of the first triangular prism.

3. A projection type display device according to claim 1, wherein the color composition optical system comprises a cross dichroic prism.

4. A projection type display device according to claim 1, wherein:
the color composition optical system comprises a compound prism which comprises a third triangular prism, a fourth triangular prism and a fifth triangular prism, all of which have mutually different cross sectional shapes and are attached to one another;
a first dichroic film is provided between the third triangular prism and the fourth triangular prism; and
a second dichroic film is provided between the fourth triangular prism and the fifth triangular prism.

5. A projection type display device according to any one of claim 1, wherein the color separation optical system comprises:
a cross dichroic mirror which comprises a first dichroic mirror which has characteristic of reflecting one of the light beams of the plurality of colors, and a second dichroic mirror which has characteristic of reflecting rest of the light beams, to be mutually orthogonal; and
a plurality of mirrors which are arranged so as respectively to change directions of the light beams which have been reflected by the cross dichroic mirror.

6. A projection type display device according to claim 5, wherein
the mirrors deflect the directions of the light beams which have been reflected by the cross dichroic mirror through an angle which is greater than 90° and is less than 180°.

7. A projection type display device, comprising:
a color separation optical system which color-separates light from a light source into light beams of a plurality of colors;
a plurality of polarization beam splitters, one being provided for each of the light beams of the plurality of colors which have been color-separated by the color separation optical system, each of which reflects one of the color-separated light beams on a polarization splitting section which is provided for that color and emits the reflected light beam towards a reflection type light valve which is provided for each of the plurality of colors, and which also then passes modulated light which is incident from the reflection type light valve through the polarization splitting section and emits the passed modulated light;
a color composition optical system which color composes the modulated light beams of the plurality of colors which have been emitted from the polarization beam splitters; and
a projection optical system which comprises an aperture stop which projects an image using the light beams which have been color composed, wherein:
each of the polarization beam splitters which are provided for the plurality of colors is built so that an angle of incidence of the color-separated light upon an incidence face of the color-separated light becomes a predetermined angle which is different from zero, and also so that an optical axis of the modulated light which is incident upon the beam splitter from the reflection type light valve is parallel to the incidence face of the separated light beam.

8. A projection type display device according to claim 1, wherein the color separation optical system separates the light from the light source into three beams of red, green, and blue light.

9. A projection type display device according to claim 8, wherein the color separation optical system comprises:
a cross dichroic mirror which comprises a first dichroic mirror which has characteristic of reflecting one of the three beams of colors, and a second dichroic mirror which has characteristic of reflecting a mixture of the other two of the three beams of colors, to be mutually orthogonal;
a plurality of mirrors which respectively deflect directions of the light beams which have been reflected by the cross dichroic mirror through an angle which is greater than 90° and is less than 180°; and
a third dichroic mirror which has characteristic of reflecting one of the light beams of two colors in the mixture light beam which has been deflected by the mirrors, and of being transparent to the other of the light beams of two colors.

10. A projection type display device comprising:
a polarization beam splitter;
a reflection type light valve; and
a projection lens, wherein:
the polarization beam splitter comprises a polarization splitting section, a first triangular prism and a second triangular prism, reflects light incident from a light source at the polarization splitting section, and emits the reflected light to the reflection type light valve;
the reflection type light valve modulate the light incident from the polarization beam splitter and emits the modulated light to the polarization beam splitter;
the polarization beam splitter emits the modulated light which has passed through the polarization splitting section, to the projection lens as an analyzed light;
the projection lens projects the analyzed light;
a cross sectional shape of the first triangular prism is a right angled triangle which has a first vertex angle of 90°, a second vertex angle which is greater than 45°, and a third vertex angle which is smaller than 45°;
the polarization splitting section is provided at a contacting surface of engagement between a face of the first triangular prism which opposes the first vertex angle thereof and one of faces of the second triangular prism;
the light from the light source is incident upon an incidence face of the first triangular prism which opposes the third vertex angle thereof, and an angle of incidence of an optical axis upon the incidence face is set so that an optical axis of light which is traveling through the first triangular prism is incident upon the polarization splitting section at an angle of incidence which is the same angle as the third vertex angle.

11. A projection type display device comprising:
a polarization beam splitter;
a reflection type light valve; and
a projection lens, wherein:
the polarization beam splitter comprises a polarization splitting section and also a first triangular prism and a second triangular prism which sandwich the polarization splitting section between them, reflects light incident from a light source at the polarization splitting section, and emits the reflected light to the reflection type light valve;
the reflection type light valve modulate the light incident from the polarization beam splitter and emits the modulated light to the polarization beam splitter;
the polarization beam splitter emits the modulated light which has passed through the polarization splitting section, to the projection lens as an analyzed light;
the projection lens projects the analyzed light; and
the light from the light source is incident upon a first face of the first triangular prism with an optical axis being incident an angle of incidence which is different from zero, and light which is reflected by the polarization splitting section is emitted so that an angle of emittance of an emittance optical axis from a second face of the first triangular prism is zero degrees.

12. A projection type display device according to claim 9, wherein
light which is modulated by and is reflected from the reflection type light valve is incident upon a second face of the first triangular prism with an angle of incidence of an incident optical axis being zero, and the analyzed light which is emitted from the polarization beam splitter is emitted so that an angle of emittance of an emittance optical axis from an emittance face of the second triangular prism is zero degrees.

13. A polarization beam splitter comprising:
an incidence face upon which light beam is incident;
a polarization splitting plane that is obliquely arranged to achieve a predetermined angle which is smaller than 90° and greater than 45° between the incidence face and the polarization splitting plane;
a first emitting face that is arranged perpendicular to the incidence face and from which light beam which has been incident upon the incidence face and has been reflected at the polarization splitting plane is emitted; and
a second emitting face that is arranged parallel to the first emitting face and from which light beam which has been incident upon the first emitting face and has passed through the polarization splitting plane is emitted.

14. A projection type display device, comprising:
a color separation optical system which separates light from a light source into light beams of a plurality of colors; and
a plurality of polarization beam splitters, one being provided for each of the light beams of the plurality of colors which have been separated by the color separation optical system, wherein:
each of the polarization beam splitters is a polarization beam splitter according to claim 13;
the polarization beam splitters are arranged so that in each of the polarization beam splitters, the light beam separated by the color separation optical system is incident upon the polarization splitting plane with an incident angle achieving by subtracting the predetermined angle from 90 degrees.

15. A projection type display device according to claim 14, wherein:
the color separation optical system separates the light from the light source into light beams of three colors;
three of the polarization beam splitters are provided; and
the three of the polarization beam splitters are arranged so that the second emitting faces of the adjacent polarization beam splitters are perpendicular to each other.

16. A projection type display device according to claim 15, further comprising:
modulation devices each of which is arranged at a side of the first emitting face of the polarization beam splitter, modulates light beam emitted from the first emitting face of the polarization beam splitter, emits the modulated light beam to the first emitting face;
a color composition optical system which is arranged at sides of the second emitting faces of the polarization beam splitters, color composes the modulated light beams emitted from the second emitting faces; and
a projection optical system which projects an image using the color composed light beams and has an aperture stop having a numerical aperture smaller than a predetermined value.

17. A projection type display device according to claim 7, wherein the color separation optical system separates the light from the light source into three beams of red, green, and blue light.
